(19) United States
(12) Patent Application Publication
(10) Pub. No.: US 2015/0161590 A1
(43) Pub. Date: Jun. 11, 2015

(54) SYSTEM AND METHOD FOR CONDUCTING A TRANSACTION USING A FUEL DISPENSING NOZZLE

(71) Applicant: MASTERCARD ASIA PACIFIC PTE. LTD., Singapore (SG)

(72) Inventor: Ruben Salazar GENOVEZ, Singapore (SG)

(73) Assignee: MASTERCARD ASIA PACIFIC PTE. LTD., Singapore (SG)

(21) Appl. No.: 14/560,566

(22) Filed: Dec. 4, 2014

(30) Foreign Application Priority Data
Dec. 6, 2013 (SG) 201309062-6

(51) Int. Cl. G06Q 20/32; G06Q 20/40; G06K 7/10

(52) U.S. Cl. CPC G06Q 20/3278; G06K 7/10386; G06Q 20/40

(57) ABSTRACT

The system includes a wireless payment device coupleable to a vehicle, the wireless payment device having account data stored thereon; a fuel dispensing nozzle coupleable to a fuel supply and configurable to dispense fuel through the nozzle from the fuel supply, the fuel dispensing nozzle comprising a wireless transceiver capable of wireless communication with the wireless payment device, a controller in communication with the fuel dispensing nozzle, the controller being operable to receive the account data from the wireless payment device via the wireless transceiver; and a payment server in communication with the controller, the payment server being operable to receive the account data from the controller and to send authorization data to the controller based on the account data; wherein the controller is operable to control the fuel dispensing nozzle to dispense fuel on receipt of the authorization data.

### FIELD OF INVENTION

The invention relates to a system and a method for conducting a transaction using a fuel dispensing nozzle.

### BACKGROUND

It is known to provide payment cards to facilitate the performing of transactions electronically. A customer may have one or more payment cards, such as, for example, one or more credit or debit cards. The customer may use one of the payment cards in conjunction with a merchant's device (e.g. an electronic point of sale) to perform a transaction with the merchant. For example, the customer may wish to purchase goods or services from the merchant, and so the customer may use the payment card to transfer funds or payment into the merchant's account in exchange for receiving the goods or services from the merchant. The payment card may be fitted with a wireless communications interface such as a Near Field Communication (NFC) interface to enable the payment card to electronically communicate with the merchant's device to perform the transaction.

NFC is a set of standards to establish radio communication between devices by bringing them into close proximity such as only a few centimeters. NFC standards cover communication protocols and data exchange formats, and are based on radio-frequency identification (RFID) technology.

Currently, when a motorist wishes to purchase fuel at a fuel station, he typically prepays for his fuel at a cashier, for example, by way of a debit/credit card or cash. Thereafter, the cashier activates the fuel dispenser and the motorist can proceed to re-fuel. If necessary, the motorist returns to the cashier to close the transaction.

Some fuel stations have self-service facilities where users can prepay for their fuel at a self-service console at the fuel dispenser. The user may need to provide some sort of authentication (e.g. a personal identification number (PIN)) to proceed with the transaction. Once the transaction is approved, the user can proceed to re-fuel. A receipt can be printed out at the self-service console. An advantage of this self-service system over the cashier-based system is that user need not walk to the cashier, queue to pay for the transaction and then walk back to the vehicles.

However, the current self-service system requires users to have their debit/credit card with them when they wish to purchase fuel. Once at the fuel station, they need to find their debit/credit card, swipe their card, key in their PIN at the self-service console and then keep their card.

A need therefore exists to provide a system and method for conducting a transaction using a fuel dispensing nozzle that seeks to address at least the above-mentioned problems.

### SUMMARY

According to the first aspect of the invention, there is provided a system for conducting a transaction using a fuel dispensing nozzle, comprising: a wireless payment device coupleable to a vehicle, the wireless payment device having account data stored thereon; a fuel dispensing nozzle coupleable to a fuel supply and configurable to dispense fuel through the nozzle from the fuel supply, the fuel dispensing nozzle comprising a wireless transceiver capable of wireless communication with the wireless payment device, a controller in communication with the fuel dispensing nozzle, the controller being operable to receive the account data from the wireless payment device via the wireless transceiver; and a payment server in communication with the controller, the payment server being operable to receive the account data from the controller and to send authorization data to the controller based on the account data; wherein the controller is operable to control the fuel dispensing nozzle to dispense fuel on receipt of the authorization data.

In an embodiment, the wireless payment device may comprise a near field communication (NFC) payment chip, and the wireless transceiver may comprise a NFC transceiver capable of near field communication with the NFC payment chip.

In an embodiment, the payment server may be operable to send declination data to the controller based on the account data; wherein the controller may be operable to prevent the fuel dispensing nozzle from dispensing fuel on receipt of the declination data.

In an embodiment, the controller may be operable to generate transaction data and transmit the transaction data with the account data to the payment server; and the payment server may be operable to send authorization data to the controller based on the transaction data.

In an embodiment, the fuel dispensing nozzle further may comprise a user interface configured in use to receive an input from a user, the user interface may be operable to send the input to the controller, and wherein the controller may be operable to generate the transaction data based on the input.

In an embodiment, the transaction data may comprise a transaction amount and the payment server may be operable to determine whether the transaction amount is below a pre-determined threshold and to send the authorization data to the controller only if the transaction amount is below the pre-determined threshold.

In an embodiment, the transaction data may comprise good/service data and the payment server may be operable to determine whether the good/service data is fuel-related and to send the authorization data to the controller only if the good/service data is fuel-related.

In an embodiment, the transaction data may comprise merchant data and the payment server may be operable to determine whether the merchant data corresponds to a pre-determined merchant and to send the authorization data to the controller only if the merchant data corresponds to the pre-determined merchant.

In an embodiment, the transaction data may comprise a transaction timestamp and the payment server may be operable to determine, based on the transaction timestamp, a time interval since a previous transaction and to send the authorization data to the controller only if the time interval is longer than a pre-determined time interval.

In an embodiment, the transaction data may comprise a transaction amount and the payment server may be operable to determine what funds are available in an account corresponding to the account data and to send the authorization data to the controller only if the funds available are equal to or greater than the transaction amount.

In an embodiment, the controller may be further operable to send activation data that is associated with the wireless payment device to the payment server; and the payment server is further operable to send registration data to the controller based on receipt of the activation data from the controller; wherein the controller is operable to control the fuel dispensing nozzle to dispense fuel on receipt of the registration data.

According to the second aspect of the invention, there is provided a fuel dispensing nozzle coupleable to a fuel supply, the fuel dispensing nozzle comprising a wireless transceiver capable of wireless communication with a wireless payment device to receive account data from the wireless payment device; the fuel dispensing nozzle being operable to communicate with a controller to receive authorization data therefrom and being operable to dispense fuel through the nozzle from the fuel supply based on the authorization data from the controller. In an embodiment, the wireless payment device may comprise a near field communication (NFC) payment chip, and the wireless transceiver may comprise a NFC transceiver capable of near field communication with the NFC payment chip.

In an embodiment, the fuel dispensing nozzle may be operable to communicate with the controller to receive declination data therefrom and may be operable to prevent fuel from being dispensed through the nozzle from the fuel supply based on the declination data from the controller.

In an embodiment, the fuel dispensing nozzle may further comprise a user interface to obtain an input from a user, the user interface may be operable to send the input to the controller.

According to the third aspect of the invention, there is provided a device comprising: a wireless payment device; and a carrier coupled to the wireless payment device, the carrier being operable in use to attach the device to a vehicle. In an embodiment, the wireless payment device may comprise a near field communication (NFC) payment chip.

In an embodiment, the carrier may comprise a locator arranged to locate the device in or on the vehicle. In an embodiment, the carrier may comprise an adhesive to adhere the device to the vehicle. Alternatively, or additionally, the carrier may comprise a bracket adapted to fit a corresponding slot on the vehicle to attach the device to a vehicle.

According to the fourth aspect of the invention, there is provided method of conducting a transaction using a fuel dispensing nozzle comprising a wireless transceiver, comprising the steps of: coupling a wireless payment device to a vehicle, the wireless payment device having account data stored thereon; bringing the fuel dispensing nozzle into close proximity to the wireless payment device to establish wireless communication between the wireless transceiver and the wireless payment device; causing a controller in communication with the fuel dispensing nozzle to receive the account data from the wireless payment device via the wireless transceiver; causing a payment server in communication with the controller to receive the account data from the controller and to send authorization data to the controller based on the account data; and causing the controller to control the fuel dispensing nozzle to dispense fuel on receipt of the authorization data.

In an embodiment, the step of establishing wireless communication between the wireless transceiver and the wireless payment device comprises establishing near field communication between a near field communication (NFC) payment chip of the wireless payment device and a NFC transceiver of the wireless transceiver.

In an embodiment, the step of establishing wireless communication between the wireless transceiver and the wireless payment device may comprise bringing the fuel dispensing nozzle into close proximity to the wireless payment device.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1 is a schematic diagram of a system for conducting a transaction using a fuel dispensing nozzle, according to an embodiment of the invention;

FIG. 2 is a flow chart illustrating a method of conducting a transaction using a fuel dispensing nozzle comprising an NFC transceiver, according to an embodiment of the invention;

FIG. 3 is a sequence diagram of a method of conducting a transaction using a fuel dispensing nozzle, according to an embodiment of the invention; and

FIG. 4 is a schematic of a computer system for implementing the system and method for conducting a transaction using a fuel dispensing nozzle in example embodiments of the invention.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Embodiments of the present invention relate to a system and a method for conducting a transaction using a fuel dispensing nozzle. Embodiments of the present invention also relate to the fuel dispensing nozzle. In the following description, a fuel station may have one or more fuel supplies. Such fuel supplies may include underground fuel storage tanks for storing various fuels such as petrol and diesel. The fuel station typically has one or more fuel dispensers, each fuel dispenser is connected to the one or more fuel supplies. Each fuel dispenser usually comprises meters to indicate the amount of fuel that is dispensed and the associated cost, and one or more fuel dispensing nozzles, wherein each nozzle is adapted to dispense a particular type or grade fuel (e.g. diesel, compressed natural gas, high octane petrol, low octane petrol, etc.).

Embodiments of the present invention can also be used in charging stations for electrical vehicles. In this instance, the “fuel dispensing nozzle” is the electrical socket for plugging into the electrical vehicles.

In the following description, reference is made to a near field communication (NFC) payment chip, and a NFC transceiver capable of near field communication with the NFC payment chip. However, it will be appreciated by a person skilled in the art that a NFC payment chip is merely an example of a wireless payment device, and a NFC transceiver is merely an example of a wireless transceiver. The wireless transceiver is capable of wireless communication using a suitable protocol with the wireless payment device. For example, embodiments of the invention may be implemented using WiFi or Bluetooth transceivers that are capable of communicating with WiFi/Bluetooth-enabled payment devices. It will be appreciated by a person skilled in the art that depending on the wireless communication protocol used, appropriate handshaking procedures may need to be carried out to establish communication between the wireless payment device and the wireless transceiver. For example, in the case of Bluetooth communication, discovery and pairing of the wireless payment device and the wireless transceiver may be carried out to establish communication.

Accordingly, an embodiment of the present invention relates to a system for conducting a transaction using a fuel dispensing nozzle comprising a wireless payment device, the fuel dispensing nozzle comprising a wireless transceiver capable of wireless communication with the wireless payment device.

In another embodiment, there is provided a fuel dispensing nozzle coupleable to a fuel supply, the fuel dispensing nozzle comprising a wireless transceiver capable of wireless communication with a wireless payment device to receive account data from the wireless payment device; the fuel dispensing nozzle being operable to communicate with a controller to receive authorization data therefrom and being operable to dispense fuel through the nozzle from the fuel supply based on the authorization data from the controller.

In another embodiment, there is provided a device comprising: a wireless payment device; and a carrier coupled to the wireless payment device, the carrier being operable in use to attach the device to a vehicle.

In a further embodiment, there is provided a method of conducting a transaction using a fuel dispensing nozzle comprising a wireless transceiver, comprising the steps of: coupling a wireless payment device to a vehicle, the wireless payment device having account data stored thereon; establishing wireless communication between the wireless transceiver and the wireless payment device; causing a controller in communication with the fuel dispensing nozzle to receive the account data from the wireless payment device via the wireless transceiver; causing a payment server in communication with the controller to receive the account data from the controller and to send authorization data to the controller based on the account data; and causing the controller to control the fuel dispensing nozzle to dispense fuel on receipt of the authorization data.

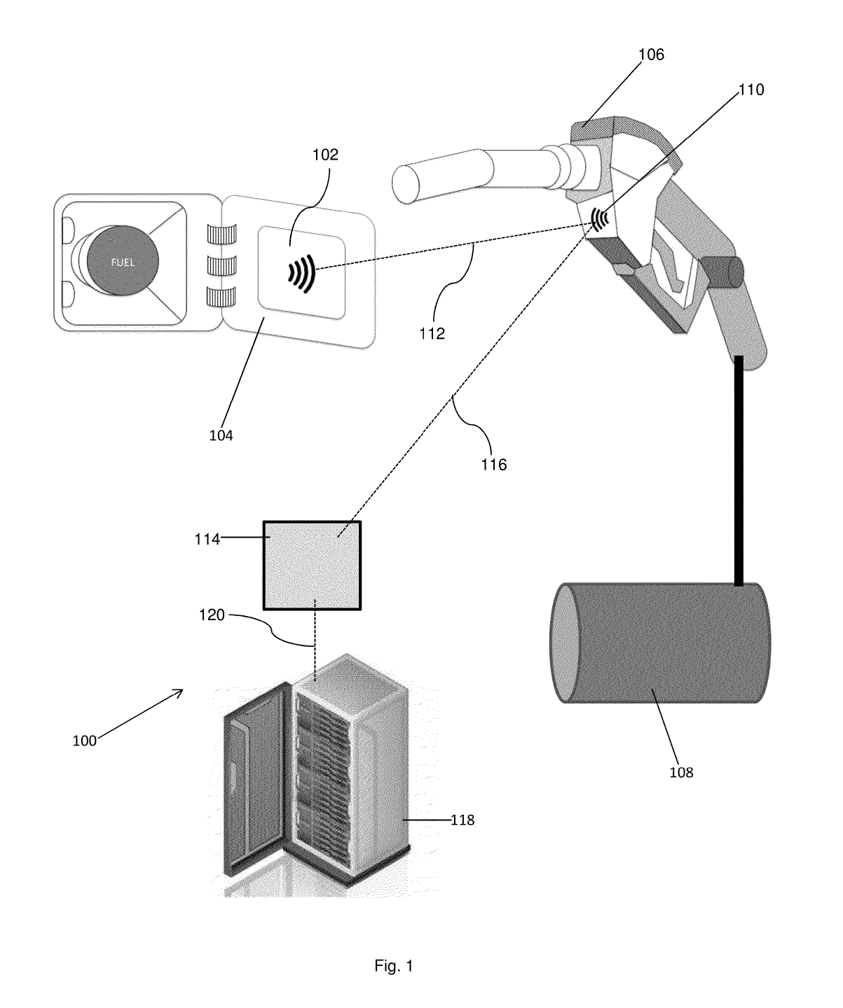

With reference to FIG. 1, according to an embodiment of the present invention, there is provided a system 100 for conducting a transaction using a fuel dispensing nozzle, comprising the following components:

A near field communication (NFC) payment chip 102 that is coupleable to a vehicle, for example on the fuel cap lid 104 of the vehicle. The NFC payment chip has payment account data stored thereon and the payment account is linked to one or more of: a debit account, a prepaid account, and/or a credit account.

A fuel dispensing nozzle 106 that is coupleable to a fuel supply 108 and configurable to dispense fuel through the nozzle 106 from the fuel supply 108. The fuel dispensing nozzle 106 comprises an NFC transceiver 110 capable of near field communication 112 with the NFC payment chip 102. For example, the NFC transceiver 110 (together with its associated hardware) can be located within the housing of the fuel dispensing nozzle 106.

A controller 114 in communication 116 with the fuel dispensing nozzle 106, the controller 114 being operable to receive the account data from the NFC payment chip 102 via the NFC transceiver 110. The controller 114 may be located in a fuel dispenser, in the fuel dispensing nozzle, or at a remote location away from a fuel station (as shown in FIG. 1).

A payment server 118 in communication 120 with the controller 114, the payment server 118 being operable to receive the account data from the controller 114 and to send authorization data to the controller 114 based on the account data. The payment server 118 is also operable to send declination data to the controller 114 based on the account data.

The payment server 118 may be at a remote location away from a fuel station (as shown in FIG. 1). The account data may include an account number.

The controller 114 is operable to control the fuel dispensing nozzle 106 to dispense fuel on receipt of the authorization data from the payment server 118. The controller is also operable to prevent the fuel dispensing nozzle 106 from dispensing fuel on receipt of the declination data from the payment server 118.

In an exemplary embodiment, the controller is further operable to generate transaction data and transmit the transaction data with the account data to the payment server. The payment server is operable to send authorization data or declination data to the controller based on the transaction data.

In an example embodiment, the fuel dispensing nozzle further comprises a user interface (not shown in FIG. 1), for example a keyboard or touch screen, configured in use to receive an input from a user. The user interface is operable to send the input to the controller, and the controller is operable to generate the transaction data based on the input. Examples of the input from the user include: accepting or declining the transaction upon successful authorization (i.e. upon receipt of authorization data), the amount of fuel to be purchased, and the amount of money to be spent on fuel.

In an example embodiment, the user interface can be in the form of buttons placed on the fuel dispensing nozzle. The user can press the relevant buttons to input his selection. Alternatively, the user interface can be a graphical user interface displayed on a display device (e.g. LCD screen with touch-sensitive buttons). For instance, for accepting or declining the transaction upon successful authorization, the buttons “YES” and “NO” can be provided. There may also be buttons displaying the amount of fuel to be purchased (e.g. “10 l”, “20 l”, “FULL-TANK”) and the amount of money to be spent on fuel (e.g. “$20”, “$40”, “$60”). For example, upon successful authorization, a user can press the “YES” button followed by the “20 l” button if he wishes to purchase 20 l worth of fuel.

In an example embodiment, a display device can also be placed on the fuel dispensing nozzle to provide relevant information to the user or to prompt the user for his input. For example, information such as the final transaction amount, balance in a debit account and/or merchant loyalty points can be shown. Also, the display device can display messages such as “Transaction Authorized—Start Re-fuel?” or “Please select the amount of fuel to be purchased” so that the user is prompted to input his appropriate choice in the user interface.

In a further exemplary embodiment, upon receipt of the input from the controller, the controller is operable to generate transaction data based on the input. The transaction data can be transmitted with the account data to the payment server. The payment server is operable to send authorization data to the controller based on the transaction data.

In an embodiment, the transaction data comprises data that is descriptive of the transaction and can be used to limit unauthorized spending, for example, in the event of theft of the NFC payment device or a vehicle having the NFC payment device.

For example, the transaction data may comprise a transaction amount. The payment server is operable to determine whether the transaction amount is below a pre-determined threshold (e.g. $150) and to send the authorization data to the controller only if the transaction amount is below the pre-determined threshold. In this way, unauthorized transactions involving large sums of money can be avoided.

The transaction data may also comprise good/service data. The good/service data is descriptive of the good or service purchased. For example, transactions involving the purchase of petrol, diesel, compressed natural gas, and other vehicle fuels can be tagged as fuel-related purchases. The payment server is operable to determine whether the good/service data is fuel-related and to send the authorization data to the controller only if the good/service data is fuel-related. In this way, the NFC payment device may not be used for non fuel-related purchases, e.g. groceries, clothes, etc. in order to limit unauthorized spending.

The transaction data may further comprise merchant data (e.g. name and location of fuel station). The payment server is operable to determine whether the merchant data corresponds to a pre-determined merchant and to send the authorization data to the controller only if the merchant data corresponds to the pre-determined merchant. In this way, transactions can also be restricted to a pre-determined fuel station or chain of fuel stations to limit unauthorized spending.

The transaction data may also comprise a transaction timestamp. The payment server is operable to determine, based on the transaction timestamp, a time interval since a previous transaction and to send the authorization data to the controller only if the time interval is longer than a pre-determined time interval. In this way, unauthorized purchase of large amounts of fuel in a short span of time can be avoided.

The transaction data can also be used to approve the transaction only if there are sufficient funds in a debit/pre-paid account, or a credit limit of a credit account has been not been exceeded. For example, the transaction data may comprise a transaction amount and the payment server is operable to determine what funds are available in an account corresponding to the account data and to send the authorization data to the controller only if the funds available are equal to or greater than the transaction amount.

According to another embodiment of the present invention, there is provided a fuel dispensing nozzle coupleable to a fuel supply, the fuel dispensing nozzle comprising an NFC transceiver capable of near field communication with a NFC payment chip to receive account data from the NFC payment chip. The fuel dispensing nozzle is operable to communicate with a controller to receive authorization data therefrom and is further operable to dispense fuel through the nozzle from the fuel supply based on the authorization data from the controller. The fuel dispensing nozzle is also operable to communicate with the controller to receive declination data therefrom and is operable to prevent fuel from being dispensed through the nozzle from the fuel supply based on the declination data from the controller. The fuel dispensing nozzle may further comprise a user interface to obtain an input from a user, the user interface being operable to send the input to the controller.

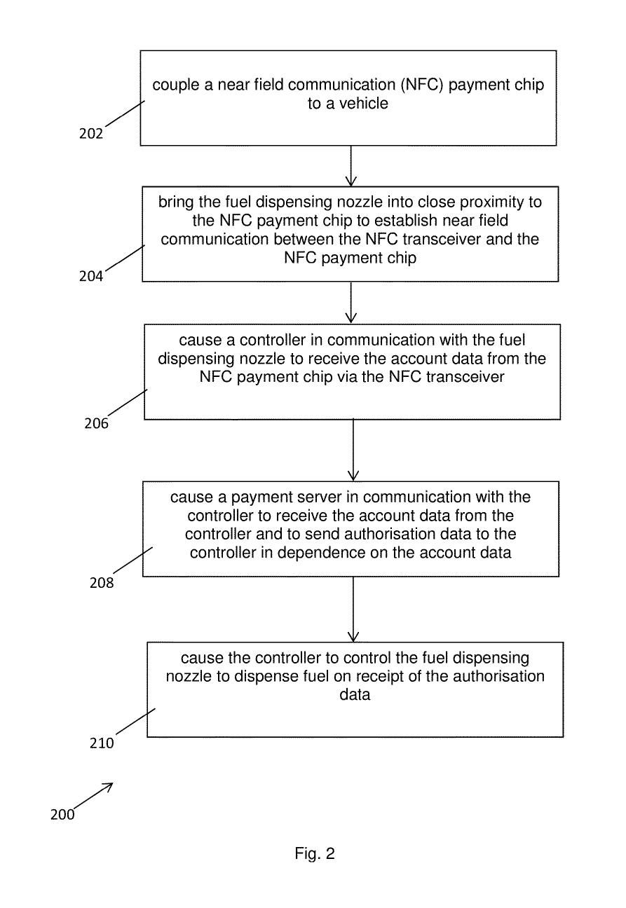

With reference to FIG. 2, according to another embodiment of the invention, there is provided a method of conducting a transaction using a fuel dispensing nozzle comprising an NFC transceiver. The method (designated generally as reference numeral 200) comprises the following steps:

Step 202: Coupling a near field communication (NFC) payment chip to a vehicle, the NFC payment chip having account data stored thereon.

For example, the NFC payment chip can be attached to the vehicle using an adhesive (e.g. in the form of a sticker). Alternatively, a bracket that is able to securely retain the NFC payment chip can be provided. The bracket is adapted to fit a corresponding slot on the vehicle to attach the NFC payment chip to the vehicle.

Step 204: Bringing the fuel dispensing nozzle into close proximity (such as only a few centimeters) to the NFC payment chip to establish near field communication between the NFC transceiver and the NFC payment chip.

The NFC payment chip is preferably placed at a location that is near the vehicle's fuel tank opening, such as the fuel cap lid, so that the fuel dispensing nozzle comprising the NFC transceiver can be easily brought into close proximity to the NFC payment chip during refueling.

Step 206: Causing a controller in communication with the fuel dispensing nozzle to receive the account data from the NFC payment chip via the NFC transceiver. For example, after near field communication between the NFC transceiver and the NFC payment chip is established, the controller can be configured to fetch/poll the account data from the NFC payment chip via the NFC transceiver. Alternatively, the account data may be sent to the controller once near field communication between the NFC transceiver and the NFC payment chip the controller is established.

The account data, which may include an account number, can be used for authorization of the transaction.

Step 208: Causing a payment server in communication with the controller to receive the account data from the controller and to send authorization data to the controller based on the account data. For example, the payment server may be configured to continuously fetch/poll the account data from the controller. Alternatively, the controller may be configured to send the account data to the payment server once the controller has received the account data.

The payment server can be configured to perform check(s) to determine whether the transaction can be authorized. An example of such a check is to determine if there are sufficient funds in an account corresponding to the account number. If there are sufficient funds, the transaction can be authorized and the payment server can be configured to send authorization data to the controller. On the other hand, if there are insufficient funds, the transaction can be declined and the payment server can be configured to send declination data to the controller.

Step 210: Causing the controller to control the fuel dispensing nozzle to dispense fuel on receipt of the authorization data.

If the transaction is declined, step 210 may involve causing the controller to prevent the fuel dispensing nozzle from dispensing fuel on receipt of the declination data to the controller.

For example, on receipt of the authorization data, the controller may enable a switch/valve to activate the fuel dispensing nozzle to dispense fuel. Similarly, on receipt of the declination data, the controller may disable the switch/valve to prevent the fuel dispensing nozzle from dispensing fuel.

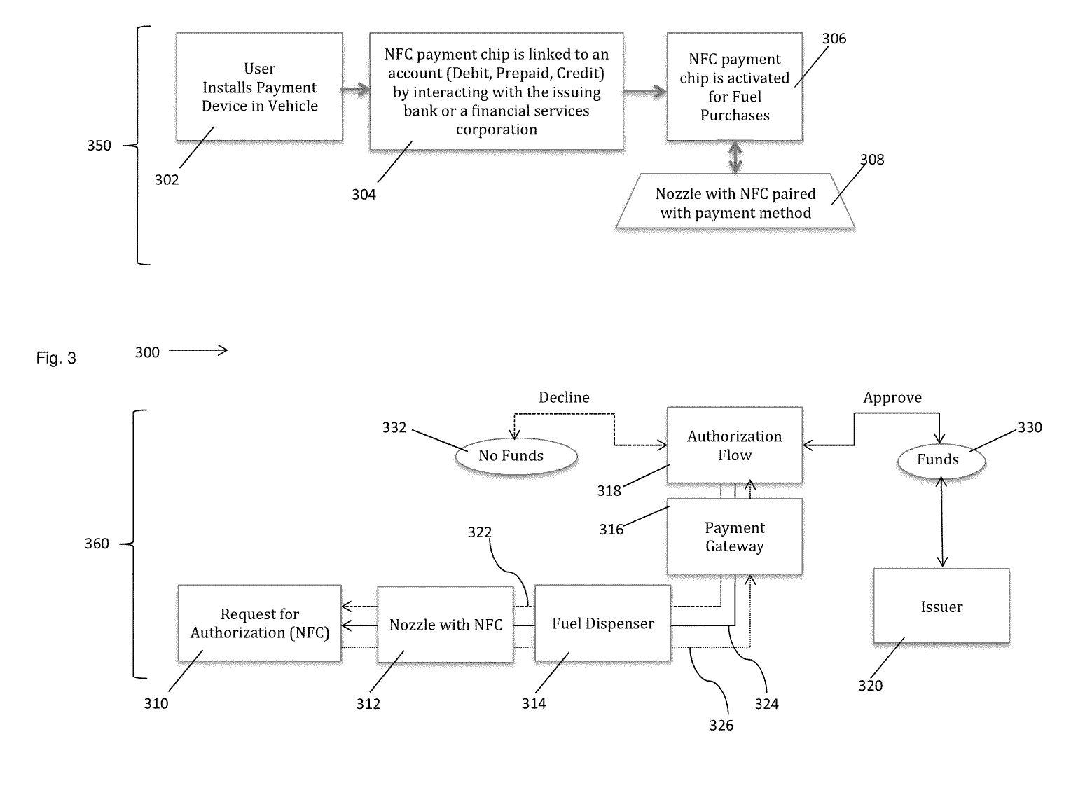

FIG. 3 is a sequence diagram, designated generally as reference numeral 300, of a method of conducting a transaction using a fuel dispensing nozzle, according to an embodiment of the invention. The method comprises two separate phases: an enrollment (e.g. configuration) phase 350 and a verification (e.g. use) phase 360.

The enrollment phase 350 includes four initialization steps (302, 304, 306 and 308) which are performed prior to the verification phase. These four initialization steps are preferably only performed once. After these four initialization steps are completed, a user only needs to perform the steps in the verification phase 360 to repeat the transaction.

The four initialization steps of the enrollment phase 350 are: installation step 302, linking step 304, activation step 306 and pairing step 308. At installation step 302, a user installs a payment device in his vehicle. The device comprises a near field communication (NFC) payment chip and a carrier coupled to the NFC payment chip. The carrier is operable in use to attach the device to a vehicle. The carrier may comprise an adhesive to adhere the device to the vehicle, or may comprise a bracket adapted to fit a corresponding slot on the vehicle to attach the device to a vehicle. The device is preferably placed at a location that is near the vehicle's fuel tank opening, such as the fuel cap lid, so that a fuel dispensing nozzle comprising a NFC transceiver can be easily brought into close proximity (such as only a few centimeters) with the NFC payment chip. The NFC payment chip has payment account data stored thereon. Alternatively, the NFC payment chip may be embedded in the body of the vehicle. For example, the NFC payment chip may be formed integrally with (i.e. be part of) a fuel cap lid of a car.

At linking step 304, the user links the NFC payment chip to an account (e.g. a debit account, prepaid account, or credit account) by interacting with the issuing bank or a financial services corporation (e.g. MasterCard™). Alternatively, the issuing bank or the financial services corporation can pre-link the NFC payment chip to an account so that the user can skip step 104. Details on the process of linking a NFC payment chip to an account are known and are not relevant to the present invention, and therefore will not be elaborated further.

At activation step 306, the NFC payment chip is activated for fuel-related purchases. As described above, in the event of theft of the NFC payment chip or a vehicle having the NFC payment chip, restrictions such as the NFC payment chip being capable of only facilitating fuel-related purchases seek to limit unauthorized spending.

In an example embodiment, the NFC payment chip is activated by using communication schemes such as short messages, web interfaces or phone, to instruct the payment server 118, to authorize future transactions by linking the NFC chip 102 to the payment method.

In an alternative embodiment, the NFC payment chip 102 is activated during a first transaction at the fuel dispenser, by utilizing the controller 114 to instruct the payment server 118 to authorize future transactions. For that purpose, controller 114 may be configured to request one or more forms of authentication, for example a personal identification number or a one-time code. The user interface of the fuel dispensing nozzle 106 can be used to prompt and receive the one or more forms of authentication from the user. After successful authentication, the controller 114 can send activation data to the payment server 118 to activate the NFC payment chip 102 for future use. The activation data is associated with the NFC payment chip 102 and may comprise data identifying the NFC payment chip 102 so that the server 118 can recognize and allow future transactions involving the NFC payment chip 102.

The payment server 118 may be operable to receive the activation data from the controller 114. Upon receipt of the activation data, the server 118 may be configured to recognize and allow future transactions involving the NFC payment chip 102 and may then send registration data to the controller 114. In other words, the server 118 sends registration data to the controller 114 based on receipt of the activation data from the controller 114 so that the NFC payment chip 102 can be used in future transactions. The controller 114 is operable to control the fuel dispensing nozzle 106 to dispense fuel on receipt of the registration data. The same methods and communication paths can be utilized in case of de-activation of the NFC payment chip. The activation step 306 is preferably only performed once, but can also be performed prior to every transaction.

At pairing step 308, the dispensing nozzle comprising the NFC transceiver is paired with a payment method. In an example embodiment, the pairing with the payment method occurs by instructing payment server 118 about the authorized payment methods to fund the purchases performed by the NFC payment chip 102. The pairing step can be executed by the operators of the payment server 118 on behalf of the user, or by allowing users direct access to instruct the payment server 118.

Once the four initialization steps (302, 304, 306 and 308) are performed, the enrollment phase 350 is complete. The verification phase 360 can commence and is performed whenever a user wishes to refuel his vehicle.

The fuel dispensing nozzle may comprise a user interface configured in use to receive an input from the user, e.g. accepting or declining the transaction upon successful authorization, the amount of fuel to be purchased, the amount of money to be spent on fuel. The user interface can be in the form of buttons placed on the fuel dispensing nozzle. The user can press the relevant buttons to input his selection. For instance, for accepting or declining the transaction upon successful authorization, the buttons “YES” and “NO” can be provided. There may also be buttons displaying the amount of fuel to be purchased (e.g. “10 l”, “20 l”, “FULL-TANK”) and the amount of money to be spent on fuel (e.g. “$20”, “$40”, “$60”).

A display device can also be placed on the fuel dispensing nozzle to provide relevant information to the user or to prompt the user for his input. For example, information such as the final transaction amount, balance in a debit account and/or merchant loyalty points can be shown. Also, the display device can display messages such as “Transaction Authorized—Start Re-fuel?” or “Please select the amount of fuel to be purchased” so that the user is prompted to input his appropriate choice in the user interface.

Suppose the user is at a fuel station and wishes to refuel his vehicle with $40 worth of petrol. The user brings the fuel dispensing nozzle comprising the NFC transceiver in close proximity (such as only a few centimeters) with the NFC payment device such that the NFC transceiver is capable of near field communication with the NFC payment chip.

At step 310, once near field communication between the NFC transceiver and the NFC payment chip is established, a request for authorization is initiated. In FIG. 3, the dotted arrows 326 designate an “authorization request”, the dashed arrows 322 designate a “decline flow”, and the solid arrows 324 designate an “approval flow”. The message “Please select the amount of fuel to be purchased” may be displayed on the display device. The user then presses the “$40” button on the user interface.

The request for authorization is sent to a payment gateway 316 via the fuel dispensing nozzle 312 and fuel dispenser 314. The payment gateway 316 may be implemented on a payment server. The payment gateway 316 can be configured to process and authorize payment transactions. For example, the payment gateway 316 can be configured to obtain the account data (e.g. account number) and transaction data (e.g. “transaction amount of $40” and “fuel-related purchase”) for authorization of the transaction.

There may be one or more conditions for authorization, including sufficient funds in a debit/pre-paid account, or a credit limit of a credit account has been not been exceeded. For example, if the condition for authorization is the requirement for sufficient funds in a debit/pre-paid account, account data (comprising the account number) is obtained from the NFC payment chip. The payment gateway 316 checks with an issuer (e.g. a bank) 320 or financial services corporation if there are sufficient funds in the debit/pre-paid account identified by the account number. If there are sufficient funds, as indicated by 330, an authorization flow 318 is initiated. In this instance, the authorization flow 318 involves an approval flow 324 and the payment gateway 316 sends authorization data to a controller. The controller may be disposed in the fuel dispenser 314 or in the fuel dispensing nozzle 312. The controller is operable to control the fuel dispensing nozzle 312 to dispense fuel on receipt of the authorization data from the payment gateway 316.

On the other hand, if there are insufficient funds as indicated by 332, the authorization flow 318 is initiated and involves a decline flow 322 and the payment gateway 316 sends declination data to the controller. The controller is operable to prevent the fuel dispensing nozzle 312 from dispensing fuel on receipt of the declination data from the payment gateway 316.

Optionally, the payment gateway 316 checks that the transaction relates to the purchase of fuel based on transaction data received from the controller. If the transaction is fuel-related, an approval flow 324 is initiated and the payment gateway sends authorization data to the controller.

Embodiments of the present invention advantageously allow users to refuel at fuel stations without having to carry along their debit/credit cards or cash. Furthermore, the transaction at the fuel stations can be authorized and completed at the fuel dispenser, without the user having to walk to the cashier, queue to pay for the transaction and walk back to the vehicle. Embodiments of the present invention advantageously provide quicker and smoother transactions at fuel stations.

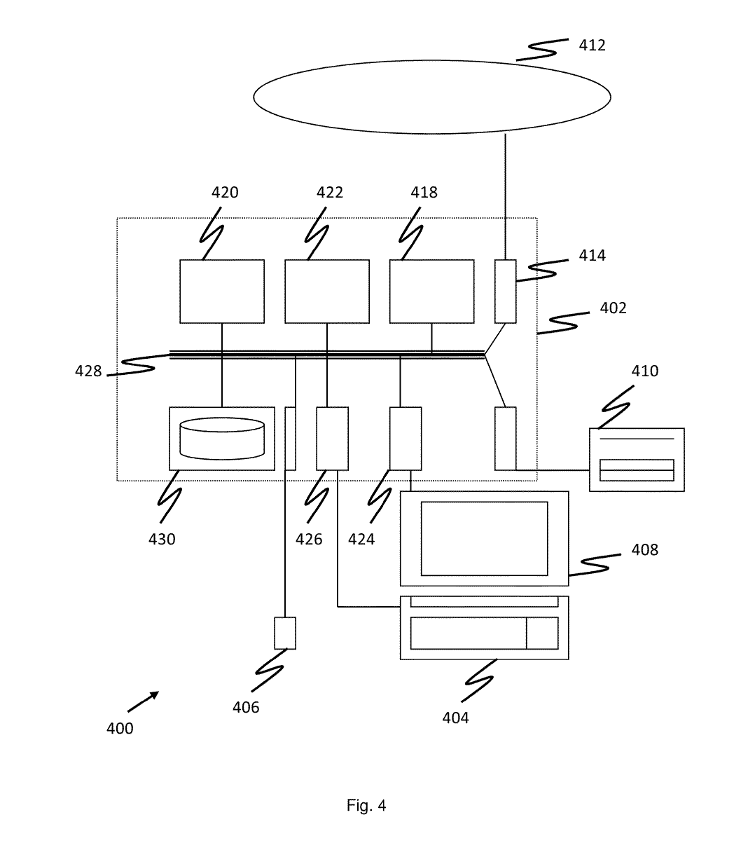

The method(s) and/or system(s) of the example embodiments can be at least partly implemented on a computer system 400, schematically shown in FIG. 4. It may be implemented as software, such as a computer program being executed within the computer system 400, and instructing the computer system 400 to conduct the method of the example embodiment. For example, the payment server 118 can be implemented using the computer system 400.

The computer system 400 comprises a computer module 402, input modules such as a keyboard 404 and mouse 406 and a plurality of output devices such as a display 408, and printer 410.

The computer module 402 is connected to a computer network 412 via a suitable transceiver device 414, to enable access to e.g. the Internet or other network systems such as Local Area Network (LAN) or Wide Area Network (WAN).

The computer module 402 in the example includes a processor 418, a Random Access Memory (RAM) 420 and a Read Only Memory (ROM) 422. The computer module 402 also includes a number of Input/Output (I/O) interfaces, for example I/O interface 424 to the display 408, and I/O interface 426 to the keyboard 404.

The components of the computer module 402 typically communicate via an interconnected bus 428 and in a manner known to the person skilled in the relevant art.

The application program is typically supplied to the user of the computer system 400 encoded on a data storage medium such as a CD-ROM or flash memory carrier and read utilizing a corresponding data storage medium drive of a data storage device 430. The application program is read and controlled in its execution by the processor 418. Intermediate storage of program data may be accomplished using RAM 420.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

What is claimed is:

1. A system for conducting a transaction using a fuel dispensing nozzle, comprising:
a wireless payment device coupleable to a vehicle, the wireless payment device having account data stored thereon;
a fuel dispensing nozzle coupleable to a fuel supply and configurable to dispense fuel through the nozzle from the fuel supply, the fuel dispensing nozzle comprising a wireless transceiver capable of wireless communication with the wireless payment device,
a controller in communication with the fuel dispensing nozzle, the controller being operable to receive the account data from the wireless payment device via the wireless transceiver; and
a payment server in communication with the controller, the payment server being operable to receive the account data from the controller and to send authorization data to the controller based on the account data;
wherein the controller is operable to control the fuel dispensing nozzle to dispense fuel on receipt of the authorization data.

2. The system of claim 1, wherein the wireless payment device comprises a near field communication (NFC) payment chip, and the wireless transceiver comprises a NFC transceiver capable of near field communication with the NFC payment chip.

3. The system of claim 1, wherein the payment server being operable to send declination data to the controller based on the account data;
wherein the controller is operable to prevent the fuel dispensing nozzle from dispensing fuel on receipt of the declination data.

4. The system of claim 1, wherein the controller being operable to generate transaction data and transmit the transaction data with the account data to the payment server; and the payment server being operable to send authorization data to the controller based on the transaction data.

5. The system of claim 4, wherein the fuel dispensing nozzle further comprises a user interface configured in use to receive an input from a user, the user interface being operable to send the input to the controller, and wherein the controller is operable to generate the transaction data based on the input.

6. The system of claim 5, wherein the transaction data comprises a transaction amount and the payment server is operable to determine whether the transaction amount is below a pre-determined threshold and to send the authorization data to the controller only if the transaction amount is below the pre-determined threshold.

7. The system of claim 5, wherein the transaction data comprises good/service data and the payment server is operable to determine whether the good/service data is fuel-related and to send the authorization data to the controller only if the good/service data is fuel-related.

8. The system of claim 5, wherein the transaction data comprises merchant data and the payment server is operable to determine whether the merchant data corresponds to a pre-determined merchant and to send the authorization data to the controller only if the merchant data corresponds to the pre-determined merchant.

9. The system of claim 5, wherein the transaction data comprises a transaction timestamp and the payment server is operable to determine, based on the transaction timestamp, a time interval since a previous transaction and to send the authorization data to the controller only if the time interval is longer than a pre-determined time interval.

10. The system of claim 5, wherein the transaction data comprises a transaction amount and the payment server is operable to determine what funds are available in an account corresponding to the account data and to send the authorization data to the controller only if the funds available are equal to or greater than the transaction amount.

11. The system of claim 1, wherein the controller is further operable to send activation data that is associated with the wireless payment device to the payment server; and the payment server is further operable to send registration data to the controller based on receipt of the activation data from the controller; and wherein the controller is operable to control the fuel dispensing nozzle to dispense fuel on receipt of the registration data.

12. A fuel dispensing nozzle coupleable to a fuel supply, the fuel dispensing nozzle comprising a wireless transceiver capable of wireless communication with a wireless payment device to receive account data from the wireless payment device;
the fuel dispensing nozzle being operable to communicate with a controller to receive authorization data therefrom and being operable to dispense fuel through the nozzle from the fuel supply based on the authorization data from the controller.

13. The fuel dispensing nozzle of claim 12, the fuel dispensing nozzle being operable to communicate with the controller to receive declination data therefrom and being operable to prevent fuel from being dispensed through the nozzle from the fuel supply based on the declination data from the controller.

14. The fuel dispensing nozzle of claim 12, further comprising a user interface to obtain an input from a user, the user interface being operable to send the input to the controller.

15. The fuel dispensing nozzle of claim 12, wherein the wireless payment device comprises a near field communication (NFC) payment chip, and the wireless transceiver comprises a NFC transceiver capable of near field communication with the NFC payment chip.

16. A device comprising:
a wireless payment device; and
a carrier coupled to the wireless payment device, the carrier being operable in use to attach the device to a vehicle.

17. The device of claim 16, wherein the carrier comprises a locator arranged to locate the device in or on the vehicle.

18. The device of claim 16, wherein the carrier comprises an adhesive to adhere the device to the vehicle.

19. The device of claim 16, wherein the carrier comprises a bracket adapted to fit a corresponding slot on the vehicle to attach the device to a vehicle.

20. The device of claim 16, wherein the wireless payment device comprises a near field communication (NFC) payment chip.

21. A method of conducting a transaction using a fuel dispensing nozzle comprising a wireless transceiver, comprising the steps of:
coupling a wireless payment device to a vehicle, the wireless payment device having account data stored thereon;
establishing wireless communication between the wireless transceiver and the wireless payment device;
causing a controller in communication with the fuel dispensing nozzle to receive the account data from the wireless payment device via the wireless transceiver;
causing a payment server in communication with the controller to receive the account data from the controller and to send authorization data to the controller based on the account data; and
causing the controller to control the fuel dispensing nozzle to dispense fuel on receipt of the authorization data.

22. The method of claim 21, wherein the step of establishing wireless communication between the wireless transceiver and the wireless payment device comprises establishing near field communication between a near field communication (NFC) payment chip of the wireless payment device and a NFC transceiver of the wireless transceiver.

23. The method of claim 21, wherein the step of establishing wireless communication between the wireless transceiver and the wireless payment device comprises bringing the fuel dispensing nozzle into close proximity to the wireless payment device.
